(19) United States
(12) Patent Application Publication
(10) Pub. No.: US 2024/0358088 A1
(43) Pub. Date: Oct. 31, 2024

(54) AEROSOL-GENERATING SYSTEM WITH INDUCTIVE HEATING ARRANGEMENT

(71) Applicant: Philip Morris Products S.A., Neuchatel (CH)

(72) Inventors: Yannick BUTIN, Marin-Epagnier (CH); Maxime CHATEAU, Montlebon (FR); Enrico STURA, Palezieux-Village (CH)

(73) Assignee: Philip Morris Products S.A., Neuchatel (CH)

(21) Appl. No.: 18/577,574

(22) PCT Filed: Jul. 12, 2022
(86) PCT No.: PCT/EP2022/069508

§ 371 Date: Jan. 8, 2024

(30) Foreign Application Priority Data
Jul. 12, 2021 (EP) 21185047.4

(51) Int. Cl. A24F 40/57; A24F 40/20; A24F 40/465; A24F 40/53; H05B 6/06; H05B 6/10

(52) U.S. Cl. CPC A24F 40/57; A24F 40/20; A24F 40/465; A24F 40/53; H05B 6/06; H05B 6/105

(57) ABSTRACT

An inductively heated aerosol-generating system is provided, including an inductive heating arrangement having an inductor and a susceptor; and a controller to: monitor an electrical control parameter during an operational heating mode, maintain a temperature of the susceptor within an operational temperature range by controlling power supplied referring to a target value of the parameter, determine whether a response of the parameter meets a predetermined condition, and implement a change in operation if the response does not do so, power being supplied as a plurality of discrete pulses of current, the response being analyzed for each pulse to determine whether a value of the parameter rises or falls during the pulse, the controller further identifying upper and lower boundary values of the parameter, and the target value being set to a value between the upper and the lower boundary values.

The present disclosure relates to an aerosol-generating system comprising an inductive heating arrangement and to a method of controlling an inductive heating arrangement. In particular, the disclosure relates to an aerosol-generating system comprising an inductive heating arrangement and a method of controlling the inductive heating arrangement in an aerosol-generating system to maintain temperature within a predetermined range without overheating.

A growing number of aerosol-generating systems, such as e-cigarettes and heated tobacco systems, comprise an inductive heating arrangement that is configured to heat an aerosol-forming substrate to produce an aerosol. Inductive heating arrangements typically comprise an inductor that inductively couples to a susceptor. The inductor generates an alternating magnetic field that causes heating in the susceptor. Typically, the susceptor is in direct contact with the aerosol-forming substrate and heat is transferred from the susceptor to the aerosol-forming substrate primarily by conduction. The temperature of the susceptor must be controlled in order to provide for optimal aerosol generation, both in terms of the amount of aerosol generated and in terms of its composition.

In most inductively heated aerosol-generating devices, vapour generated by the heating of the aerosol-forming substrate is carried away from the susceptor by an airflow. The vapour cools in the airflow to generate the aerosol. In some aerosol-generating devices, in which the aerosol is intended for inhalation, the airflow may be generated by a user puffing on the device. A user puffing on the device provides an intermittent and irregular airflow past the susceptor. This airflow past the susceptor cools the susceptor. So, during operation, more power must be provided to the inductor to counteract the cooling effect of the airflow and ensure optimal aerosol generation. The additional power must be provided as a response to a detected user puff.

Therefore, it is important for such aerosol-generating devices to accurately monitor and control the temperature of the susceptor to ensure optimum generation and delivery of an aerosol to a user and to be able to respond to cooling events, such as a user puffing on the device.

Inductive heating arrangements provide contactless heating of a susceptor. This is beneficial in many circumstances, in particular when the susceptor is provided in a separate component of the system to the inductor. For the same reason, it is desirable to monitor and control susceptor temperature without requiring direct electrical connection to the susceptor and without requiring a separate, dedicated temperature sensor. An apparent resistance or an apparent conductance of the susceptor within an inductive circuit can be monitored to provide an indication of susceptor temperature. The power supplied to the inductor can then be controlled to provide a desired susceptor temperature.

However, there are circumstances in which control simply based on the relationship between apparent resistance or apparent conductance and temperature may lead to a risk that the susceptor is heated to an incorrect temperature. In those circumstances, simply relying on heating to a target value of apparent resistance or apparent conductance does not eliminate the possibility of overheating occurring. One such circumstance may be the relative movement of the susceptor and the alternating magnetic field during aerosol-generation. Another such circumstance may be the temporary presence of a magnetic element that interferes with the alternating magnetic field during aerosol-generation.

It would desirable to provide an inductive heating arrangement and control method that increases the confidence that a susceptor is being heated to a predetermined operating temperature range, thereby reducing the possibility of overheating the susceptor.

According to an embodiment of the invention, there is provided an inductively heated aerosol-generating system. The system comprises an inductive heating arrangement, having an inductor and a susceptor. The system comprises a controller configured to monitor an electrical control parameter during an operational heating mode. The controller is configured to maintain a temperature of the susceptor within an operational temperature range. The temperature of the susceptor is maintained within the operational temperature range by controlling power supplied to the inductive heating arrangement with reference to a target value of the electrical control parameter. The controller is configured to determine whether a response of the electrical control parameter to power supplied to the inductive heating arrangement during the operational heating mode meets a predetermined condition.

For example, the inductively heated aerosol-generating system may comprise an inductive heating arrangement, having an inductor and a susceptor; and a controller configured to monitor an electrical control parameter during an operational heating mode and to maintain temperature of the susceptor within an operational temperature range by controlling power supplied to the inductive heating arrangement with reference to a target value of the electrical control parameter. The controller may be configured to determine whether a response of the electrical control parameter to power supplied to the inductive heating arrangement during the operational heating mode meets a predetermined condition. The controller may be configured to implement a change in operation if the response does not meet the predetermined condition. The change in operation may be a modification of the operational heating mode, for example a pause of the operational heating mode, or a cessation or termination of the operational heating mode. The change in operation may comprise a step of switching from the operational heating mode to a different operational mode, for example to a recovery mode, or a calibration mode. The change in operation may result in power supplied to the inductive heating arrangement being reduced, for example the duty cycle may be reduced, or the power supply may be terminated. Preferably, the change in operation results in the cooling of the susceptor.

The monitoring of a suitable electrical control parameter, such as apparent resistance, or apparent conductance, may allow the temperature of the susceptor to be determined. This, in turn, may allow control of susceptor temperature by controlling power supplied to the inductive heating arrangement with reference to a target value of the electrical control parameter. For example, energy may be supplied to the inductive heating arrangement and such energy supply may be reduced or switched off when a value of the electrical control value equals a value corresponding to a target temperature of the susceptor. The energy supply may be resumed after a short period of time and the process repeated, thereby maintaining temperature of the susceptor within a predetermined temperature range. This process may work well until an anomaly changes the relationship between the electrical control parameter and temperature of the susceptor. In such circumstances, supplying energy to the inductive heating arrangement with reference to the target value of the electrical control parameter may result in the temperature of the susceptor falling outside the desired operating range. In some circumstances, the susceptor may be excessively heated, leading to a potential overheating of an aerosol-forming substrate. By checking that the response of the electrical control parameter to power supplied is an expected response, by checking that the response to supplied power meets a predetermined condition, it can be determined whether or not there has been an anomaly or a change in circumstance that may lead to the temperature of the susceptor falling outside of the desired operating range. Advantageously, an anomaly or change that may result in overheating of the susceptor may be detected at an early stage, preferably before such overheating has become detectable to a user of the system. Particularly advantageously, the controller may be able to take corrective action should any such anomaly or change occur, which may prevent any overheating reaching a critical level, and may allow a user to continue a user experience.

The controller may be configured to maintain temperature of the susceptor within the operational temperature range by supplying power to the inductive heating arrangement, monitoring the electrical control parameter, and modifying the power supplied to the inductive heating arrangement when a value of the electrical control parameter equals the target value of the electrical control parameter. The controller may be configured to control a duty cycle of the power supplied to the inductive heating arrangement to maintain a value of the electrical control parameter to approximately equal the target value of the electrical control parameter.

In preferred examples, the controller may be configured to supply pulses of current, for example a plurality of pulses of current, to the inductive heating arrangement to maintain temperature of the susceptor within the desired operational temperature range. A pulse may be terminated if a value of the electrical control parameter equals the target value of the electrical control parameter during the pulse. The susceptor may then cool slightly, during a period in which no current is supplied to the inductive heating arrangement, before a subsequent pulse. The result is that the temperature of the susceptor can be maintained at about a temperature corresponding to the target temperature of the electrical control parameter.

Where power is supplied to the inductive heating arrangement as pulses of current, the step of determining whether the response of the electrical control parameter to the power supplied meets the predetermined condition may be conducted for each pulse of current. Preferably, a change of operation is implemented if the predetermined condition is not met over the duration of a pulse. By checking that the predetermined condition is met for each pulse, any anomaly or change in circumstance can be detected swiftly, preferably before the temperature of the susceptor has deviated greatly from the desired operating temperature range.

Preferably, the electrical control parameter is indicative of temperature of the susceptor. The electrical control parameter may be indicative of a material property of the susceptor that varies as a function of temperature. The electrical control parameter may be a parameter that varies as a function of temperature of the susceptor. Preferably, the electrical control parameter is a parameter selected from the list consisting of; electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement. Such parameters may be monitored directly, or determined in real time by monitoring other parameters and applying an appropriate calculation.

In some examples, the controller may be configured to monitor at least one power parameter representative of power supplied to the inductive heating arrangement during operation. The at least one power parameter may be used as the electrical control parameter, or the at least one power parameter may be used to derive the electrical control parameter. The at least one power parameter may be, or may comprise, current supplied to the inductive heating arrangement during operation. The at least one power parameter may be, or may comprise, voltage across the inductive heating arrangement during operation.

As an example, apparent conductance of the inductive heating arrangement may be calculated by the formula σ=I/V, where σ is apparent conductivity of the inductive heating arrangement, I is current delivered to the inductive heating arrangement, and V is voltage across the inductive heating arrangement. Thus, if power is delivered at constant voltage, the apparent conductance may be determined in real time by monitoring the current and applying the formula. Both current and voltage may be monitored, and monitored values of both of these parameters used to calculate the apparent conductance. Apparent resistance is the inverse of apparent conductance, and can be calculated using the formula ρ=V/I, where ρ is the apparent resistance.

The predetermined condition is a condition that the electrical control parameter must fulfil in response to power being supplied to the inductive heating arrangement during the heating mode. The predetermined condition may be that a value of the electrical control parameter rises in response to power supplied to the inductive heating arrangement during the operational heating mode, for example rises towards the target value of the control parameter in response to power supplied to the inductive heating arrangement during the operational heating mode. The predetermined condition may be that a value of the electrical control parameter does not fall in response to power supplied to the inductive heating arrangement during the operational heating mode.

In some examples, power may be supplied to the inductive heating arrangement as a plurality of discrete pulses of current. The predetermined condition may be that a value of the electrical control parameter rises in response to each pulse of current supplied to the inductive heating arrangement during the operational heating mode, for example rises towards the target value of the control parameter in response to each pulse of current supplied to the inductive heating arrangement during the operational heating mode. The predetermined condition may be that a value of the electrical control parameter does not fall in response to each pulse of current supplied to the inductive heating arrangement during the operational heating mode.

If the predetermined condition is met then no modification needs to be made to the operational heating mode. If the predetermined condition is not met, then the system is preferably configured to implement a change, for example to mitigate or prevent any potential overheating of the susceptor.

The predetermined condition may be that a value of the electrical control parameter falls in response to power supplied to the inductive heating arrangement during the operational heating mode, for example falls towards the target value of the control parameter in response to power supplied to the inductive heating arrangement during the operational heating mode. The predetermined condition may be that a value of the electrical control parameter fails to rise in response to power supplied to the inductive heating arrangement during the operational heating mode. Where power is supplied to the inductive heating arrangement as a plurality of discrete pulses of current, the predetermined condition may be that a value of the electrical control parameter falls, or fails to rise, in response to each pulse of current supplied to the inductive heating arrangement during the operational heating mode.

In some examples the electrical control parameter may a parameter selected from the list consisting of; electrical conductance of the susceptor, apparent electrical conductance of the inductive heating arrangement, current supplied to the inductive heating arrangement, and power supplied to the inductive heating arrangement, and the system may be configured such that a value of the electrical control parameter rises in response to power supplied to the inductive heating arrangement during the operational heating mode, for example rises towards the target value of the control parameter in response to power supplied to the inductive heating arrangement during the operational heating mode. In such cases, the predetermined condition may be that a value of the electrical control parameter rises in response to power supplied to the inductive heating arrangement, and if the electrical control parameter does not rise in response to power supplied it is an indication that there may be an anomaly in the system that is affecting the heating of the susceptor.

In some examples the electrical control parameter may a parameter selected from the list consisting of; electrical resistance of the susceptor, and apparent electrical resistance of the inductive heating arrangement, and the system may be configured such that a value of the electrical control parameter falls in response to power supplied to the inductive heating arrangement during the operational heating mode, for example falls towards the target value of the control parameter in response to power supplied to the inductive heating arrangement during the operational heating mode.

The inductive heating arrangement may be configured to assist temperature monitoring and temperature control. In some example, at least a portion of the susceptor may be configured to undergo a reversible phase transition when heated through a predetermined temperature range. The predetermined temperature range would be a temperature range that starts below an onset temperature of the reversible phase change and ends above an end temperature of the reversible phase change. The predetermined temperature range may be, for example, between 100° C. and 500° C., for example between 200° C. and 400° C.

Preferably, the controller is configured to identify upper and lower boundary values of the electrical control parameter associated with upper and lower boundaries of the phase transition. Advantageously, the target value of the electrical control parameter may be set to a value between the upper and lower boundary values. The target value may be a predetermined target value, but advantageously, the target value may be determined following identification of the upper and lower boundary values of the electrical control parameter.

An advantageous example may provide inductively heated aerosol-generating system as described above comprising, an inductive heating arrangement having an inductor and a susceptor; and a controller configured to monitor an electrical control parameter, the controller being configured to maintain temperature of the susceptor during an operational heating mode within a desired operational temperature range by controlling power supplied to the inductive heating arrangement with reference to a target value of the electrical control parameter, in which, at least a portion of the susceptor is configured to undergo a reversible phase transition when heated through a predetermined temperature range, and in which the controller is configured to identify upper and lower boundary values of the electrical control parameter associated with upper and lower boundaries of the phase transition, and in which the target value of the electrical control parameter is set to a value between the upper and lower boundary values, and in which the response of the electrical control parameter to power supplied to the inductive heating arrangement during the operational heating phase is monitored, for example to determine whether the temperature of the susceptor is within the desired operational temperature range.

Preferably, the controller is configured to monitor at least one power parameter representative of power supplied to the inductive heating arrangement during operation, and to use the power parameter to derive the electrical control parameter.

In any example it is preferable that the susceptor is located within, or locatable within, an alternating electromagnetic field generated by the inductor. The susceptor may be a fixed susceptor, for example a fixed portion of an aerosol-generating device. The susceptor may be a susceptor located within or as part of an aerosol-generating article.

Where at least a portion of the susceptor undergoes a phase transition, upper and lower boundary values of the electrical control parameter may be determined by monitoring and/or analysing the response of the electrical control parameter as the susceptor is heated through a predetermined temperature range. For example variations in values of the electrical control parameter may be recorded as the susceptor is heated through the predetermined temperature range and upper and lower boundary values may be determined, for example by detecting maxima and/or minima in values of the electrical control parameter as the susceptor is heated through the predetermined temperature range.

As the susceptor is heated through the predetermined temperature range, a phase transition start point and a phase transition end point may be identifiable by changes in the value of the electrical control parameter as the susceptor is heated through a predetermined temperature range. Advantageously, the target value of the electrical control parameter may be determined to be between values of the electrical control parameter at the phase transition start point and the phase transition end point.

The inductive heating arrangement may exhibit a reversal in apparent resistance, or apparent conductance, while undergoing the phase transition. For example, the apparent resistance of the inductive heating system may increase as temperature of the susceptor increases prior to onset of the phase transition. The apparent resistance may then decrease on heating through the phase transition, and increase again on heating beyond the end of the phase transition. For example, the apparent conductance of the inductive heating system may decrease as temperature of the susceptor increases prior to onset of the phase transition. The apparent conductance may then increase on heating through the phase transition, and decrease again on heating beyond the end of the phase transition.

Thus, values of the electrical control parameter may experience maxima and minima as the susceptor is heated or cooled through its phase transition. Advantageously, the operational temperature range may be bounded by maxima and minima values of the electrical control parameter. This may allow for a specific response of the electrical control parameter to power supplied to the inductive heating arrangement. That is, when the susceptor is heated within the temperature range under which it undergoes a phase transition, the electrical control parameter may respond differently to applied power compared to when the temperature of the susceptor is outside temperature range under which it undergoes a phase transition. Thus, the response of the electrical control parameter to power supplied to the inductive heating arrangement may provide an indication of whether the temperature of the susceptor is within the desired operational temperature range or not.

Preferably, power is supplied to the inductive heating arrangement as a plurality of discrete pulses of current, and the response of the electrical control parameter is determined and/or analysed for each pulse of current to determine whether the value of the electrical control parameter rises or falls during the pulse. For example, the response to the electrical control parameter may be analysed for each pulse of current to determine whether a slope of the electrical control parameter versus time curve increases or decreases over the duration of the pulse.

In some examples, the electrical control parameter is apparent conductance of the inductive heating system, and the control parameter is analysed for each pulse of current to determine whether the value of the electrical control parameter rises or falls over the duration of the pulse. Preferably, the operational temperature range is a temperature range in which the apparent conductance of the inductive heating arrangement rises on application of power. Advantageously, the controller may be configured to switch from the heating mode to a recovery mode if it detects that the value of the electrical control parameter falls over the duration of a pulse, as this may indicate that the temperature of the susceptor has fallen outside the operational temperature range.

The operational temperature range is preferably selected to optimise generation of aerosol from an aerosol-forming substrate. The operational temperature range may be set by a target operational temperature, and the system may be configured to maintain the temperature of the susceptor as close to the target operational temperature as possible. The operational temperature range may be between 100° C. and 500° C., for example between 200° C. and 400° C. Preferred operational temperature ranges may be between 300° C. and 400° C., for example between 350° C. and 390° C. The operational heating mode may have a target operational temperature of between 300° C. and 400° C., for example between 350° C. and 390° C., for example about 350° C., or 360° C., or 370° C., or 380° C.

In examples where the susceptor exhibits a reversible phase transition when heated through a predetermined temperature range, the phase transition may be a magnetic phase transition or a crystallographic phase transition. For example, the phase transition may be a ferro-magnetic/paramagnetic phase transition, or a ferri-magnetic/paramagnetic phase transition, or an antiferro-magnetic/paramagnetic phase transition. For example, the susceptor, or a portion of the susceptor may be a material that undergoes a Curie transition within the predetermined temperature range.

The susceptor may be configured for optimisation of heating efficiency, while still undergoing a reversible phase transition within the predetermined temperature range. Thus, the susceptor may comprise a first material that does not undergo the reversible phase transition during the predetermined temperature range and a second material that does undergo the reversible phase transition during the predetermined temperature range. The first material may comprise greater than 50% by volume of the susceptor, preferably greater than 60% by volume, or greater than 70% by volume, or greater than 80% by volume, or greater than 90% by volume, or greater than 95% by volume. The first material may be an iron based alloy, for example a stainless steel. The second material may be nickel or a nickel based alloy. The second material may be present as patches of material deposited onto the first material. The second material may be encapsulated by the first material. The second material may be layered onto or encapsulate the first material.

Advantageously, a target value of the electrical control parameter may be determined to correspond to a susceptor temperature no greater than a Curie temperature of a material in the susceptor. The susceptor may comprise a first susceptor material having a first Curie temperature and second susceptor material having a second Curie temperature. The second Curie temperature may be lower than the first Curie temperature. The target value of the electrical control parameter may correspond to a susceptor temperature no greater than the second Curie temperature.

The first and second susceptor materials are preferably two separate materials that are joined together and therefore are in intimate physical contact with each other, whereby it is ensured that both susceptor materials have the same temperature due to thermal conduction. The two susceptor materials are preferably two layers or strips that are joined along one of their major surfaces. The susceptor may further comprise yet an additional third layer of susceptor material. The third layer of susceptor material is preferably made of the first susceptor material. The thickness of the third layer of susceptor material is preferably less than the thickness of the layer of the second susceptor material.

The target value of the electrical control parameter may correspond to a susceptor temperature lying within a range of temperatures in which a conductance of the susceptor increases monotonically with increasing temperature. At the lower end of this range of temperatures a material in the susceptor may begin a phase change from a ferro-magnetic or ferri-magnetic state to a paramagnetic state. At the upper end of this range of temperatures the material may have completed the phase change from a ferro-magnetic or ferri-magnetic state to a paramagnetic state.

The susceptor may be formed as a unitary component, for example as an elongated pin, blade, wire, or strip, or as a sheet or mesh. The susceptor may be an elongated susceptor, having a length dimension greater than a width dimension or a thickness dimension. The susceptor may have a rectangular transverse cross-section, or a circular transverse cross-section. The susceptor may be in the form of a strip of material or a strip of foil.

The susceptor may have a length of between 8 mm and 100 mm, for example between 10 mm and 30 mm, for example between 12 mm and 20 mm. The susceptor may have a width of between 2 mm and 6 mm, for example between 3 mm and 5 mm, for example between 3.5 mm and 4.5 mm. The susceptor may have a thickness of between 0.01 mm and 2 mm, for example between 0.05 mm and 1.5 mm, for example between 0.1 mm and 1 mm.

The susceptor may be formed from a plurality of discrete components, for example from more than one elongated pins, blades, wires, or strips, more than one sheets or meshes, or more than one particle, for example the susceptor may be formed from a plurality of particles disposed in thermal contact with, or within, the aerosol-forming substrate.

The system preferably comprises a power supply, for example a DC power supply, for example a battery located within an aerosol-generating device. The aerosol-generating device may further comprise a DC to AC convertor, for example a DC to AC inverter, to supply AC power to the inductor.

The inductor may comprise an inductor coil. The inductor coil may be a helical coil or a flat planar coil, in particular a pancake coil or a curved planar coil. The inductor may be used to generate a varying magnetic field. The varying magnetic field may be high-frequency varying magnetic field. The varying magnetic field may be in the range between 500 kHz (kilo-Hertz) to 30 MHz (Mega-Hertz), in particular between 5 MHz to 15 MHz, preferably between 5 MHz and 10 MHz. The varying magnetic field is used to inductively heat the susceptor due to at least one of Eddy currents or hysteresis losses, depending on the electrical and magnetic properties of the susceptor material.

The inductive heating arrangement may comprise a DC/AC converter, the inductor connected to the DC/AC converter. The susceptor may be arranged to inductively couple to the inductor. Power from the power source may be supplied to the inductor, via the DC/AC converter, as a plurality of pulses of electrical current, each pulse separated by a time interval. Controlling the power provided to the inductive heating arrangement may comprise controlling the time interval between each of the plurality of pulses. Controlling the power provided to the inductive heating arrangement may comprise controlling the length of each pulse of the plurality of pulses.

The system may be configured to measure, at the input side of the DC/AC converter, a DC current drawn from the power source. A conductance value or the resistance value associated with the susceptor may be determined based on a DC supply voltage of the power source and from the DC current drawn from the power source. The system may further be configured to measure, at the input side of the DC/AC converter, the DC supply voltage of the power source. This is due to the fact that there is a monotonous relationship between the actual conductance (which cannot be determined if the susceptor forms part of the article) of the susceptor and the apparent conductance determined in this way (because the susceptor will impart the conductance of the LCR-circuit (of the DC/AC converter) it will be coupled to, because the majority of the load (R) will be due to the resistance of the susceptor. The conductance is 1/R. Hence, reference to the conductance of the susceptor in this text is reference to apparent conductance if the susceptor forms part of a separate aerosol-generating article.

An aerosol-generating system as described herein preferably comprises an aerosol-generating article and an aerosol-generating device configured to receive the aerosol-generating article. The aerosol-generating article preferably comprises an aerosol-forming substrate and the susceptor is preferably arranged in thermal communication with the aerosol-forming substrate. The aerosol-generating article is preferably a disposable article, for example an article having the form of a conventional cigarette.

Preferably the aerosol-generating device comprises the inductor, the controller, and a power supply for supplying power to the controller. The aerosol-generating device may further comprises a DC/AC convertor to convert direct current supplied by the power source to alternating current for supplying the inductor. The current supplied to the DC/AC convertor may be monitored and may form the electrical control parameter, or may be used in the derivation of the electrical control parameter. The aerosol-generating device may be configured to inductively heat an aerosol-forming substrate to generate an inhalable aerosol during a usage session.

An aerosol-generating system, or aerosol-generating device for use in the system, may be configured to operate in both a calibration mode and a heating mode. The calibration mode may, for example, be used to determine a target value of the electrical control parameter, and the heating mode may be used to maintain a temperature of the susceptor at an operational temperature by controlling power supplied with reference to the target value of the electrical control parameter.

A calibration mode may comprise steps of; heating the susceptor through the predetermined temperature range, allowing the susceptor to cool through the predetermined temperature range, identifying upper and lower boundary values of the control parameter associated with upper and lower boundaries of a phase transition of the susceptor, and determining the target value of the control parameter.

The step of heating the susceptor through the predetermined temperature range may involve supplying power to the inductive heating arrangement, and monitoring the control parameter to identify boundaries of a phase transition undergone by the susceptor when heating through the predetermined temperature range.

During a calibration phase, the power supplied to heat the susceptor through the predetermined temperature range may be supplied at a duty cycle of greater than 80%, for example greater than 90%, for example 100%. The step of allowing the susceptor to cool through the predetermined temperature range may involve supplying power to the inductive heating arrangement at a reduced duty cycle and monitoring the control parameter.

The step of allowing the susceptor to cool through the predetermined temperature range may involve supplying power to the inductive heating arrangement as pulses of energy, for example pulses of current, for example pulses of energy having a duty cycle of less than 10%, for example less than 2% or less than 1%, and monitoring values of the control parameter during each of the pulses.

The controller may be configured to operate the system in a heating mode comprising steps of; supplying pulses of energy, for example pulses of current, to the inductive heating arrangement, monitoring the control parameter, and cutting a pulse if the control parameter reaches the target parameter during that pulse.

The system or device may be configured to switch from the heating mode to a recovery mode when it is determined that the response of the electrical control parameter to power supplied to the inductive heating arrangement during the heating mode does not meet the predetermined condition, for example, in one possible configuration, if a value of the electrical control parameter rises in response to power supplied to the inductive heating arrangement during the heating mode, or for example if a value of the electrical control parameter does not fall in response to power supplied to the inductive heating arrangement during the heating mode, or for example, in another possible configuration, if a value of the electrical control parameter falls in response to power supplied to the inductive heating arrangement during the heating mode, or for example if a value of the electrical control parameter fails to rise in response to power supplied to the inductive heating arrangement during the heating mode.

The recovery mode may involve a step of allowing the susceptor to cool, for example by reducing or eliminating power supplied to the inductive heating arrangement. The recovery mode may involve a recalibration to determine a new target value of the control parameter. The heating mode may be resumed after completion of the recovery mode.

According to an embodiment of the invention, an aerosol-generating device may be provided, the aerosol-generating device being configured to be used in an aerosol-generating system as described herein.

According to an embodiment of the invention, an aerosol-generating article may be provided, the aerosol-generating article configured to be used in an aerosol-generating system as described herein.

According to an embodiment of the invention, a method of controlling an induction heated aerosol-generating system comprising an inductive heating arrangement having an inductor and a susceptor; and a controller may comprise steps of;
(a) monitoring an electrical control parameter during an operational heating mode of the aerosol-generating system,
(b) maintaining temperature of the susceptor within an operational temperature range by controlling power supplied to the inductive heating arrangement with reference to a target value of the electrical control parameter,
(c) checking if a response of the electrical control parameter to power supplied to the inductive heating arrangement during the operational heating mode meets a predetermined condition, and,
(d) implementing a change in operation if the response does not meet the predetermined condition.

Step (c) may involve checking whether a value of the electrical control parameter increases or decreases in response to power supplied to the inductive heating arrangement.

A method of controlling an induction heated aerosol-generating system in which at least a portion of the susceptor is configured to undergo a reversible phase transition when heated through a predetermined temperature range may comprising steps of;
monitoring at least one power parameter representative of power supplied to the inductive heating arrangement during operation;
deriving the electrical control parameter from the power parameter;
heating the susceptor through the predetermined temperature range;
identifying upper and lower boundary values of the electrical control parameter associated with upper and lower boundaries of the phase transition;
determining the target value of the control parameter, the target value of the control parameter being between the upper and lower boundary values;
controlling power supplied to the inductive heating arrangement during an operational heating phase with reference to the target value of the electrical control parameter to maintain temperature of the susceptor within a desired operational temperature range; and
monitoring and analysing the response of the electrical control parameter to power supplied to the inductive heating arrangement during the operational heating phase to determine whether the temperature of the susceptor is within the desired operational temperature range.

If the response of the electrical control parameter is considered to be an inappropriate response, the method may comprise the step of initiating a cooling mode or a recovery mode, in which power supplied to the inductive heating arrangement is reduced or removed.

The method may be a method of controlling an aerosol-generating system as described herein.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “duty cycle” of the pulses of electrical current means the percentage of the ratio of pulse duration, or pulse width to the total period over which the pulses of current are supplied.

As used herein, the term “puff” means the action of a user drawing an aerosol into their body through their mouth or nose.

The invention is defined in the claims. However, below there is provided a non-exhaustive list of non-limiting examples. Any one or more of the features of these examples may be combined with any one or more features of another example, embodiment, or aspect described herein.

Exi. An inductively heated aerosol-generating system comprising,
an inductive heating arrangement, having an inductor and a susceptor; and
a controller configured to monitor an electrical control parameter during an operational heating mode and to maintain temperature of the susceptor within an operational temperature range by controlling power supplied to the inductive heating arrangement with reference to a target value of the electrical control parameter,
in which the controller is configured to determine whether a response of the electrical control parameter to power supplied to the inductive heating arrangement during the operational heating mode meets a predetermined condition.
   Ex1. An inductively heated aerosol-generating system comprising,
an inductive heating arrangement, having an inductor and a susceptor; and
a controller configured to monitor an electrical control parameter during an operational heating mode and to maintain temperature of the susceptor within an operational temperature range by controlling power supplied to the inductive heating arrangement with reference to a target value of the electrical control parameter,
in which the controller is configured to determine whether a response of the electrical control parameter to power supplied to the inductive heating arrangement during the operational heating mode meets a predetermined condition, and to implement a change in operation if the response does not meet the predetermined condition.
   Ex2. An aerosol-generating system according to example Ex1 in which the change in operation is a modification of the operational heating mode.
   Ex3. An aerosol-generating system according to example Ex1 in which the change in operation is a termination of the operational heating mode.
   Ex4. An aerosol-generating system according to example Ex1 or Ex2 in which the change in operation comprises a step of switching from the operational heating mode to a different operational mode, for example a recovery mode, or a calibration mode.
   Ex5. An aerosol-generating system according to any of examples Ex1 to Ex4 in which the change in operation results in the cooling of the susceptor.
   Ex6. An aerosol-generating system according to any of examples Ex1 to Ex5 in which the change in operation results in power supplied to the inductive heating arrangement being reduced, for example in which the duty cycle is reduced, or in which the power supply is terminated.
   Ex7. An aerosol-generating system according to any preceding example in which the controller is configured to maintain temperature of the susceptor within the operational temperature range by supplying power to the inductive heating arrangement, monitoring the electrical control parameter, and modifying the power supplied to the inductive heating arrangement when a value of the electrical control parameter equals the target value of the electrical control parameter.
   Ex8. An aerosol-generating system according to any preceding example in which the controller is configured to maintain temperature of the susceptor within the operational temperature range by supplying power to the inductive heating arrangement, monitoring the electrical control parameter, and controlling a duty cycle of the power supplied to the inductive heating arrangement to maintain a value of the electrical control parameter to approximately equal the target value of the electrical control parameter.
   Ex9. An aerosol-generating system according to any preceding example in which the controller is configured to supply pulses of current to the inductive heating arrangement to maintain temperature of the susceptor within the desired operational temperature range.
   Ex10. An aerosol-generating system according to example Ex9 in which a pulse is terminated if a value of the electrical control parameter equals the target value of the electrical control parameter during the pulse.
   Ex11. An aerosol-generating system according to example Ex9 or Ex10 in which determination whether the response of the electrical control parameter to power supplied to the inductive heating arrangement during the operational heating mode meets a predetermined condition is conducted for each pulse of current.
   Ex12. An aerosol-generating system according to any of examples Ex9 to Ex11 in which the change of operation is implemented if the predetermined condition is not met over the duration of a pulse.
   Ex13. An aerosol-generating system according to any preceding example, in which the electrical control parameter is indicative of temperature of the susceptor, and/or indicative of a material property of the susceptor that varies as a function of temperature, and/or in which the electrical control parameter is a parameter that varies as a function of temperature of the susceptor.
   Ex14. An aerosol-generating system according to any preceding example in which the electrical control parameter is a parameter selected from the list consisting of; electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement.
   Ex15. An aerosol-generating system according to any preceding example in which the controller is configured to monitor at least one power parameter representative of power supplied to the inductive heating arrangement during operation.
   Ex16. An aerosol-generating system according to example Ex15 in which the at least one power parameter is used as the electrical control parameter, or in which the at least one power parameter is used to derive the electrical control parameter.
   Ex17. An aerosol-generating system according to examples Ex15 or Ex16 in which the at least one power parameter is, or comprises, current supplied to the inductive heating arrangement during operation.
   Ex18. An aerosol-generating system according to any preceding example in which in which the at least one power parameter is, or comprises is, or comprises, voltage across the inductive heating arrangement during operation.
   Ex19. An aerosol-generating system according to any preceding example in which the predetermined condition is that a value of the electrical control parameter rises in response to power supplied to the inductive heating arrangement during the operational heating mode, for example rises towards the target value of the control parameter in response to power supplied to the inductive heating arrangement during the operational heating mode.
   Ex20. An aerosol-generating system according to any preceding example in which power is supplied to the inductive heating arrangement as a plurality of discrete pulses of current, and in which the predetermined condition is that a value of the electrical control parameter rises in response to each pulse of current supplied to the inductive heating arrangement during the operational heating mode, for example rises towards the target value of the control parameter in response to each pulse of current supplied to the inductive heating arrangement during the operational heating mode.
   Ex21. An aerosol-generating system according to any of examples Exi to Ex18 in which the predetermined condition is that a value of the electrical control parameter falls in response to power supplied to the inductive heating arrangement during the operational heating mode, for example falls towards the target value of the control parameter in response to power supplied to the inductive heating arrangement during the operational heating mode.
   Ex22. An aerosol-generating system according to any of examples Exi to Ex18 and Ex21 in which power is supplied to the inductive heating arrangement as a plurality of discrete pulses of current, and in which the predetermined condition is that a value of the electrical control parameter falls in response to each pulse of current supplied to the inductive heating arrangement during the operational heating mode, for example falls towards the target value of the control parameter in response to each pulse of current supplied to the inductive heating arrangement during the operational heating mode.
   Ex23. An aerosol-generating system according to any of examples Exi to Ex20 in which the electrical control parameter is a parameter selected from the list consisting of; electrical conductance of the susceptor, apparent electrical conductance of the inductive heating arrangement, current supplied to the inductive heating arrangement, and power supplied to the inductive heating arrangement, and in which a value of the electrical control parameter rises in response to power supplied to the inductive heating arrangement during the operational heating mode, for example rises towards the target value of the control parameter in response to power supplied to the inductive heating arrangement during the operational heating mode.
   Ex24. An aerosol-generating system according to any of examples Exi to Ex18, Ex21 and Ex22 in which the electrical control parameter is a parameter selected from the list consisting of; electrical resistance of the susceptor, and apparent electrical resistance of the inductive heating arrangement, and in which a value of the electrical control parameter falls in response to power supplied to the inductive heating arrangement during the operational heating mode, for example falls towards the target value of the control parameter in response to power supplied to the inductive heating arrangement during the operational heating mode.
   Ex25. An aerosol-generating system according to any preceding example in which, at least a portion of the susceptor is configured to undergo a reversible phase transition when heated through a predetermined temperature range.
   Ex26. An aerosol-generating system according to example Ex25 in which the controller is configured to identify upper and lower boundary values of the electrical control parameter associated with upper and lower boundaries of the phase transition.
   Ex27. An aerosol-generating system according to example Ex26 in which the target value of the electrical control parameter is set to a value between the upper and lower boundary values.
   Ex28. An inductively heated aerosol-generating system according to any preceding example comprising,
an inductive heating arrangement, having an inductor and a susceptor; and
a controller configured to monitor an electrical control parameter, the controller configured to maintain temperature of the susceptor during an operational heating mode within a desired operational temperature range by controlling power supplied to the inductive heating arrangement with reference to a target value of the electrical control parameter, in which, at least a portion of the susceptor is configured to undergo a reversible phase transition when heated through a predetermined temperature range, and in which the controller is configured to identify upper and lower boundary values of the electrical control parameter associated with upper and lower boundaries of the phase transition,
in which the target value of the electrical control parameter is set to a value between the upper and lower boundary values, and
in which the response of the electrical control parameter to power supplied to the inductive heating arrangement during the operational heating phase is monitored to determine whether the temperature of the susceptor is within the desired operational temperature range.
   Ex29. An inductively heated aerosol-generating system according to example Ex28 in which the controller is configured to monitor at least one power parameter representative of power supplied to the inductive heating arrangement during operation, and to use the power parameter to derive the electrical control parameter.
   Ex30. An aerosol-generating system according to any preceding example, in which the susceptor is located and/or locatable within an alternating electromagnetic field generated by the inductor.
   Ex31. An aerosol-generating system according to any of examples Ex26 to Ex30 in which the upper and lower boundary values of the electrical control parameter are determined by analysing the response of the electrical control parameter as the susceptor is heated through a predetermined temperature range, for example by analysing variations in values of the electrical control parameter as the susceptor is heated through the predetermined temperature range, for example by detecting maxima and/or minima in values of the electrical control parameter as the susceptor is heated through the predetermined temperature range.
   Ex32. An aerosol-generating system according to any preceding example, the susceptor being configured to undergo a reversible phase transition when heated through a predetermined temperature range, a phase transition start point and a phase transition end point being identifiable by changes in the value of the electrical control parameter as the susceptor is heated through a predetermined temperature range.
   Ex33. An aerosol-generating system according to example Ex32 in which the target value of the electrical control parameter is determined to be between values of the electrical control parameter at the phase transition start point and the phase transition end point, and in which the response of the electrical control parameter to power supplied to the inductive heating arrangement is referenced or analysed to identify whether the temperature of the susceptor is within the desired operational temperature range.
   Ex34. An aerosol-generating system according to any of examples Ex25 to Ex33 in which the inductive heating arrangement exhibits a reversal in apparent resistance while undergoing the phase transition.
   Ex35. An aerosol-generating system according to any of examples Ex25 to Ex34 in which the inductive heating arrangement exhibits a reversal in apparent conductance while undergoing the phase transition.
   Ex36. An aerosol-generating system according to any examples Ex25 to Ex35 in which the apparent resistance of the inductive heating system increases prior to onset of the phase transition, decreases on heating through the phase transition, and increases on heating beyond the end of the phase transition.
   Ex37. An aerosol-generating system according to any examples Ex25 to Ex36 in which the apparent conductance of the inductive heating system decreases prior to onset of the phase transition, increases on heating through the phase transition, and decreases on heating beyond the end of the phase transition.
   Ex38. An aerosol-generating system according to any preceding example in which the operational temperature range is bounded by maxima and minima values of the electrical control parameter.
   Ex39. An aerosol-generating system according to any preceding example, in which power is supplied to the inductive heating arrangement as a plurality of discrete pulses of current, in which the response of the electrical control parameter is analysed for each pulse of current to determine whether the value of the electrical control parameter rises or falls during the pulse.
   Ex40. An aerosol-generating system according to any preceding example, in which power is supplied to the inductive heating arrangement as a plurality of discrete pulses of current, in which the response to the electrical control parameter is analysed for each pulse of current to determine whether a slope of the electrical control parameter versus time curve increases or decreases over the duration of the pulse.
   Ex41. An aerosol-generating system according to example Ex39 or Ex40 in which the electrical control parameter is apparent conductance of the inductive heating system, and the control parameter is analysed for each pulse of current to determine whether the value of the electrical control parameter rises or falls over the duration of the pulse.
   Ex42. An aerosol-generating system according to example Ex41 in which the controller is configured to switch from the heating mode to a recovery mode if it detects that the value of the electrical control parameter falls over the duration of a pulse.
   Ex43. An aerosol-generating system according to example Ex41 or Ex42 in which the controller is configured to allow the susceptor to cool if it detects that the value of the electrical control parameter falls over the duration of a pulse, for example by reducing the duty cycle of power supplied to the inductive heating arrangement.
   Ex44. An aerosol-generating system according to any preceding example in which the susceptor exhibits a reversible phase transition when heated through a predetermined temperature range, in which the phase transition is a magnetic phase transition or a crystallographic phase transition.
   Ex45. An aerosol-generating system according to example Ex44 in which the phase transition is a ferro-magnetic/paramagnetic phase transition, or a ferri-magnetic/paramagnetic phase transition, or an antiferro-magnetic/paramagnetic phase transition.
   Ex46. An aerosol-generating system according to example Ex44 or Ex45 in which the susceptor comprises a first material that does not undergo the reversible phase transition during the predetermined temperature range and a second material that does undergo the reversible phase transition during the predetermined temperature range.
   Ex47. An aerosol-generating system according to example Ex46 in which the first material comprises greater than 50% by volume of the susceptor, preferably greater than 60% by volume, or greater than 70% by volume, or greater than 80% by volume, or greater than 90% by volume, or greater than 95% by volume.
   Ex48. An aerosol-generating system according to example Ex46 or Ex47 in which the first material is an iron based alloy, for example a stainless steel.
   Ex49. An aerosol-generating system according to any of examples Ex46 to Ex48 in which the second material is nickel or a nickel based alloy.
   Ex50. An aerosol-generating system according to any preceding example in which the susceptor is formed as a unitary component, for example as an elongated pin, blade, wire, or strip, or as a sheet or mesh.
   Ex51. An aerosol-generating system according to any preceding example in which the susceptor is an elongated susceptor, having a length dimension greater than a width dimension or a thickness dimension.
   Ex52. An aerosol-generating system according to any preceding example in which the susceptor has a rectangular transverse cross-section, or a circular transverse cross-section.
   Ex53. An aerosol-generating system according to any preceding example in which the susceptor has a length of between 8 mm and 100 mm, for example between 10 mm and 30 mm, for example between 12 mm and 20 mm.
   Ex54. An aerosol-generating system according to any preceding example in which the susceptor has a width of between 2 mm and 6 mm, for example between 3 mm and 5 mm, for example between 3.5 mm and 4.5 mm.
   Ex55. An aerosol-generating system according to any preceding example in which the susceptor has a thickness of between 0.1 mm and 2 mm, for example between 0.2 mm and 1.5 mm, for example between 0.4 mm and 1 mm.
   Ex56. An aerosol-generating system according to any preceding example in which the susceptor is formed from a plurality of discrete components, for example from more than one elongated pins, blades, wires, or strips, more than one sheets or meshes, or more than one particle, for example the susceptor may be formed from a plurality of particles disposed in thermal contact with, or within, the aerosol-forming substrate.
   Ex57. An aerosol-generating system according to any preceding example in which the system comprises a power supply, for example a DC power supply, for example a battery located within an aerosol-generating device, the aerosol-generating device further comprising a DC to AC convertor, for example a DC to AC inverter, to supply AC power to the inductor.
   Ex58. An aerosol-generating system according to any preceding example in which the system comprises an aerosol-generating article and an aerosol-generating device configured to receive the aerosol-generating article.
   Ex59. An aerosol-generating system according to example Ex58 in which the aerosol-generating article comprises an aerosol-forming substrate and the susceptor is arranged in thermal communication with the aerosol-forming substrate.
   Ex60. An aerosol-generating system according to example Ex58 or Ex59 in which the aerosol-generating article is a disposable article.
   Ex61. An aerosol-generating system according to any of examples Ex58 to Ex60 in which the aerosol-generating device comprises the inductor, the controller, and a power supply for supplying power to the controller.
   Ex62. An aerosol-generating system according to example Ex61 in which the aerosol-generating device further comprises a DC/AC convertor to convert direct current supplied by the power source to alternating current for supplying the inductor.
   Ex63. An aerosol-generating system according to example Ex62 in which the at least one power parameter is, or comprises, the current supplied to the DC/AC convertor.
   Ex64. An aerosol-generating system according to any preceding example comprising an aerosol-generating device configured to inductively heat an aerosol-forming substrate to generate an inhalable aerosol during a usage session.
   Ex65. An aerosol-generating system according to any preceding example in which the system is configured to operate in a calibration mode and a heating mode.
   Ex66. An aerosol-generating system according to example Ex65 in which the controller is configured to operate in a calibration mode comprising steps of; heating the susceptor through the predetermined temperature range, allowing the susceptor to cool through the predetermined temperature range, identifying upper and lower boundary values of the control parameter associated with upper and lower boundaries of the phase transition, and determining the target value of the control parameter.
   Ex67. An aerosol-generating system according to example Ex66 in which the step of heating the susceptor through the predetermined temperature range involves supplying power to the inductive heating arrangement, and monitoring the control parameter to identify boundaries of a phase transition undergone by the susceptor when heating through the predetermined temperature range.
   Ex68. An aerosol-generating system according to example Ex66 or Ex67 in which the power supplied to heat the susceptor through the predetermined temperature range is supplied at a duty cycle of greater than 80%, for example greater than 90%, for example 100%.
   Ex69. An aerosol-generating system according to any of examples Ex66 to Ex68 in which the step of allowing the susceptor to cool through the predetermined temperature range involves supplying power to the inductive heating arrangement at a reduced duty cycle, and monitoring the control parameter.
   Ex70. An aerosol-generating system according to any of examples Ex66 to Ex69 in which the step of allowing the susceptor to cool through the predetermined temperature range involves supplying power to the inductive heating arrangement as pulses of energy, for example pulses of current, for example pulses of energy having a duty cycle of less than 10%, for example less than 2% or less than 1%, and monitoring values of the control parameter during each of the pulses.
   Ex71. An aerosol-generating system according to any of examples Ex65 to Ex70 in which the controller is configured to operate in a heating mode comprising steps of; supplying pulses of energy, for example pulses of current, to the inductive heating arrangement, monitoring the control parameter, and cutting a pulse if the control parameter reaches the target parameter during that pulse.
   Ex72. An aerosol-generating system according to any of any preceding example in which the system is configured to switch from the heating mode to a recovery mode when it is determined that the response of the electrical control parameter to power supplied to the inductive heating arrangement during the heating mode does not meet the predetermined condition, for example, in one possible configuration, if a value of the electrical control parameter rises in response to power supplied to the inductive heating arrangement during the heating mode, or for example if a value of the electrical control parameter does not fall in response to power supplied to the inductive heating arrangement during the heating mode, or for example, in another possible configuration, if a value of the electrical control parameter falls in response to power supplied to the inductive heating arrangement during the heating mode, or for example if a value of the electrical control parameter fails to rise in response to power supplied to the inductive heating arrangement during the heating mode.
   Ex73. An aerosol-generating system according to example Ex72 in which the recovery mode involves a step of allowing the susceptor to cool, for example by reducing or eliminating power supplied to the inductive heating arrangement.
   Ex74. An aerosol-generating system according to example Ex72 or Ex73 in which the recovery mode involves a recalibration to determine a new target value of the control parameter.
   Ex75. An aerosol-generating system according to any of examples Ex72 to Ex74 in which the heating mode is resumed after completion of the recovery mode.
   Ex76. An aerosol-generating device configured to be used in an aerosol-generating system as defined in any preceding example.
   Ex77. An aerosol-generating article configured to be used in an aerosol-generating system as defined in any of examples Exi to Ex75.
   Ex78. A method of controlling an induction heated aerosol-generating system, the system comprising an inductive heating arrangement having an inductor and a susceptor; and a controller;
the method comprising steps of;
(a) monitoring an electrical control parameter during an operational heating mode of the aerosol-generating system, and
(b) maintaining temperature of the susceptor within an operational temperature range by controlling power supplied to the inductive heating arrangement with reference to a target value of the electrical control parameter,
(c) checking if a response of the electrical control parameter to power supplied to the inductive heating arrangement during the operational heating mode meets a predetermined condition, and,
(d) implementing a change in operation if the response does not meet the predetermined condition.
   Ex79. A method according to example Ex78 in which step (c) involves checking whether a value of the electrical control parameter increases or decreases in response to power supplied to the inductive heating arrangement.
   Ex80. A method of controlling an induction heated aerosol-generating system according to example Ex78 or Ex79, in which at least a portion of the susceptor is configured to undergo a reversible phase transition when heated through a predetermined temperature range;
the method comprising steps of;
monitoring at least one power parameter representative of power supplied to the inductive heating arrangement during operation;
deriving the electrical control parameter from the power parameter;
heating the susceptor through the predetermined temperature range;
identifying upper and lower boundary values of the electrical control parameter associated with upper and lower boundaries of the phase transition;
determining the target value of the control parameter, the target value of the control parameter being between the upper and lower boundary values;
controlling power supplied to the inductive heating arrangement during an operational heating phase with reference to the target value of the electrical control parameter to maintain temperature of the susceptor within a desired operational temperature range; and monitoring and analysing the response of the electrical control parameter to power supplied to the inductive heating arrangement during the operational heating phase to determine whether the temperature of the susceptor is within the desired operational temperature range.
   Ex81. A method according to example Ex78, Ex79, or Ex80 comprising the further step of, if the response of the electrical control parameter is considered to be an inappropriate response, initiating a cooling mode or a recovery mode, in which power supplied to the inductive heating arrangement is reduced or removed.
   Ex82. A method of controlling an aerosol-generating system as defined in any of examples Ex78 to Ex81 using an aerosol-generating system as defined in any of examples Exi to Ex75.

Examples will now be further described with reference to the figures in which:

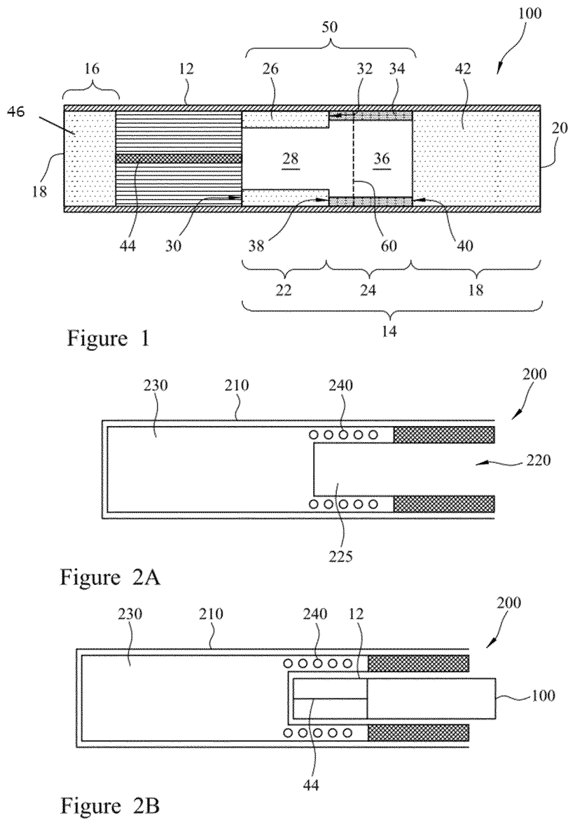

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

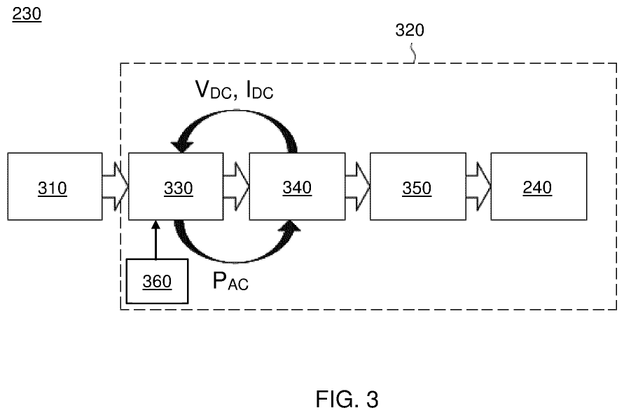

FIG. 3 is a block diagram showing an inductive heating device of the aerosol-generating device described in relation to FIG. 2;

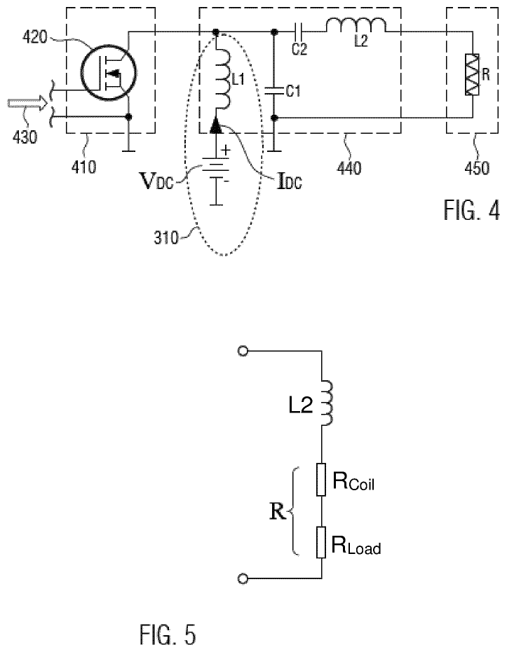

FIG. 4 is a schematic diagram showing electronic components of the inductive heating device described in relation to FIG. 3;

FIG. 5 is a schematic diagram on an inductor of an LC load network of the inductive heating device described in relation to FIG. 4;

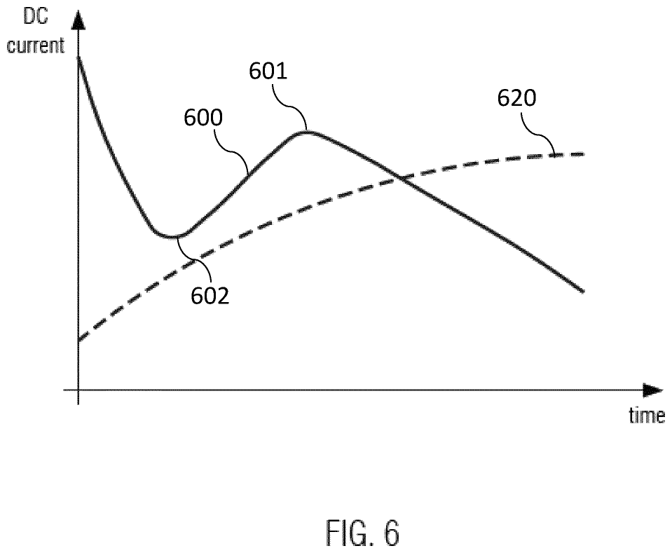

FIG. 6 is a graph of DC current vs. time illustrating the remotely detectable current changes that occur when a susceptor material undergoes a phase transition associated with its Curie point;

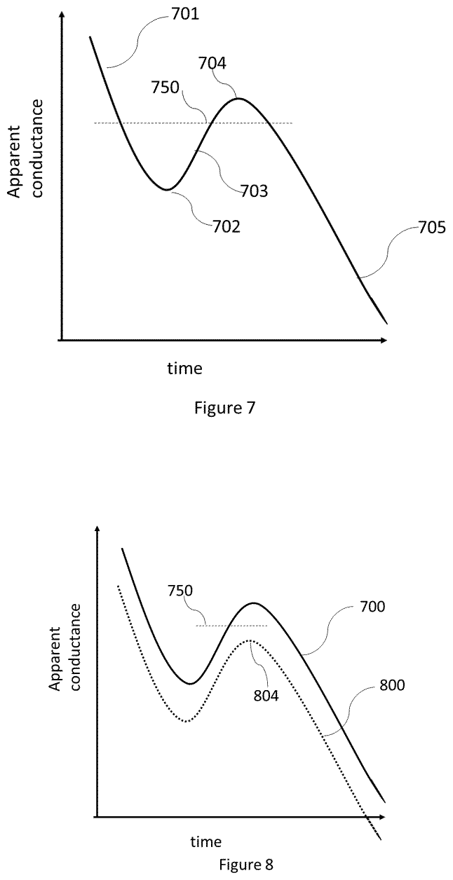

FIG. 7 is a graph of apparent conductance vs. time illustrating the remotely detectable current changes that occur when a susceptor material undergoes a phase transition associated with its Curie point;

FIG. 8 is a graph illustrating a shift in the apparent conductance curve when a susceptor moves position with respect to a conductor; and

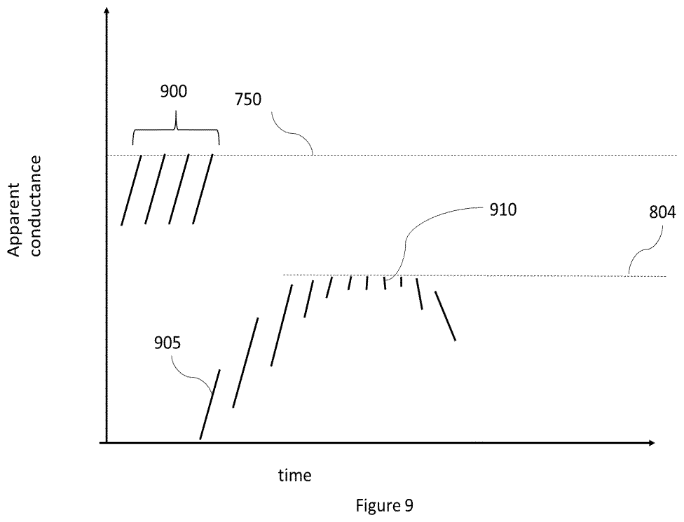

FIG. 9 is a diagram illustrating the effect that a shift in apparent conductance curve can have on the temperature control of the system.

FIG. 1 illustrates an aerosol-generating article 100 for use in an aerosol-generating system. The aerosol-generating article 100 shown in FIG. 1 comprises a rod 12 of aerosol-generating substrate and a downstream section 14 at a location downstream of the rod 12 of aerosol-generating substrate. Further, the aerosol-generating article 100 comprises an upstream section 16 at a location upstream of the rod 12 of aerosol-generating substrate. Thus, the aerosol-generating article 100 extends from an upstream or distal end 18 to a downstream or mouth end 20.

The downstream section 14 comprises a support element 22 located immediately downstream of the rod 12 of aerosol-generating substrate, the support element 22 being in longitudinal alignment with the rod 12. In the embodiment of FIG. 1, the upstream end of the support element 22 abuts the downstream end of the rod 12 of aerosol-generating substrate. In addition, the downstream section 14 comprises an aerosol-cooling element 24 located immediately downstream of the support element 22, the aerosol-cooling element 24 being in longitudinal alignment with the rod 12 and the support element 22. In the embodiment of FIG. 1, the upstream end of the aerosol-cooling element 24 abuts the downstream end of the support element 22.

The support element 22 and the aerosol-cooling element 24 together define an intermediate hollow section 50 of the aerosol-generating article 100. As a whole, the intermediate hollow section 50 does not substantially contribute to the overall RTD of the aerosol-generating article.

The support element 22 comprises a first hollow tubular segment 26. The first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment to a downstream end 32 of the first hollow tubular segment 26. The internal cavity 28 is substantially empty, and so substantially unrestricted airflow is enabled along the internal cavity 28.

The first hollow tubular segment 26 has a length of about 8 millimetres, an external diameter of about 7.25 millimetres, and an internal diameter (DFTS) of about 1.9 millimetres. Thus, a thickness of a peripheral wall of the first hollow tubular segment 26 is about 2.67 millimetres.

The aerosol-cooling element 24 comprises a second hollow tubular segment 34. The second hollow tubular segment 34 is provided in the form of a hollow cylindrical tube made of cellulose acetate. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36.

The second hollow tubular segment 34 has a length of about 8 millimetres, an external diameter of about 7.25 millimetres, and an internal diameter (D_{STS}) of about 3.25 millimetres. Thus, a thickness of a peripheral wall of the second hollow tubular segment 34 is about 2 millimetres.

The aerosol-generating article 100 comprises a ventilation zone 60 provided at a location along the second hollow tubular segment 34. In more detail, the ventilation zone is provided at about 2 millimetres from the upstream end of the second hollow tubular segment 34. A ventilation level of the aerosol-generating article 100 is about 25 percent.

In the embodiment of FIG. 1, the downstream section 14 further comprises a mouthpiece element 42 at a location downstream of the intermediate hollow section 50. In more detail, the mouthpiece element 42 is positioned immediately downstream of the aerosol-cooling element 24. As shown in the drawing of FIG. 1, an upstream end of the mouthpiece element 42 abuts the downstream end 40 of the aerosol-cooling element 18.

The mouthpiece element 42 is provided in the form of a cylindrical plug of low-density cellulose acetate. The mouthpiece element 42 has a length of about 12 millimetres and an external diameter of about 7.25 millimetres.

The rod 12 comprises an aerosol-generating substrate of one of the types described above. The rod 12 of aerosol-generating substrate has an external diameter of about 7.25 millimetres and a length of about 12 millimetres.

The aerosol-generating article 100 further comprises an elongate susceptor element 44 within the rod 12 of aerosol-generating substrate. In more detail, the susceptor element 44 is arranged substantially longitudinally within the aerosol-generating substrate, such as to be approximately parallel to the longitudinal direction of the rod 12. As shown in the drawing of FIG. 1, the susceptor element 44 is positioned in a radially central position within the rod and extends effectively along the longitudinal axis of the rod 12.

The susceptor element 44 extends all the way from an upstream end to a downstream end of the rod 12. In effect, the susceptor element 44 has substantially the same length as the rod 12 of aerosol-generating substrate.

In the embodiment of FIG. 1, the susceptor element 44 is provided in the form of a strip and has a length of about 12 millimetres, a thickness of about 60 micrometres, and a width of about 4 millimetres. The upstream section 16 comprises an upstream element 46 located immediately upstream of the rod 12 of aerosol-generating substrate, the upstream element 46 being in longitudinal alignment with the rod 12. In the embodiment of FIG. 1, the downstream end of the upstream element 46 abuts the upstream end of the rod 12 of aerosol-generating substrate. This advantageously prevents the susceptor element 44 from being dislodged. Further, this ensures that the consumer cannot accidentally contact the heated susceptor element 44 after use.

The upstream element 46 is provided in the form of a cylindrical plug of cellulose acetate circumscribed by a stiff wrapper. The upstream element 46 has a length of about 5 millimetres.

The susceptor 44 comprises at least two different materials. The susceptor 44 comprises at least two layers: a first layer of a first susceptor material disposed in physical contact with a second layer of a second susceptor material. The first susceptor material and the second susceptor material may each be materials that undergo a Curie transition and, therefore, may each have a Curie temperature. In this case, the Curie temperature of the second susceptor material is lower than the Curie temperature of the first susceptor material. The first material may not undergo a Curie transition and may not have a Curie temperature. The first susceptor material may be aluminum, iron or stainless steel. The second susceptor material may be nickel or a nickel alloy. The susceptor 44 may be formed by electroplating at least one patch of the second susceptor material onto a strip of the first susceptor material. The susceptor may be formed by cladding a strip of the second susceptor material to a strip of the first susceptor material.

In use, air is drawn through the aerosol-generating article 100 by a user from the distal end 18 to the mouth end 20. The distal end 18 of the aerosol-generating article 100 may also be described as the upstream end of the aerosol-generating article 100 and the mouth end 20 of the aerosol-generating article 100 may also be described as the downstream end of the aerosol-generating article 100. Elements of the aerosol-generating article 100 located between the mouth end 20 and the distal end 18 can be described as being upstream of the mouth end 20 or, alternatively, downstream of the distal end 18. The aerosol-forming substrate 12 is located at the distal or upstream end 18 of the aerosol-generating article 100.

The aerosol-generating article 100 illustrated in FIG. 1 is designed to engage with an aerosol-generating device of the aerosol-generating system, such as the aerosol-generating device 200 illustrated in FIG. 2A, for producing an aerosol. The aerosol-generating device 200 comprises a housing 210 having a cavity 220 configured to receive the aerosol-generating article 100. The aerosol-generating device 200 further comprises an inductive heating device 230 configured to heat an aerosol-generating article 100 for producing an aerosol. FIG. 2B illustrates the aerosol-generating device 200 when the aerosol-generating article 100 is inserted into the cavity 220.

The inductive heating device 230 is illustrated as a block diagram in FIG. 3. The inductive heating device 230 comprises a DC power source 310 and a heating arrangement 320 (also referred to as power supply electronics). The heating arrangement comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 44, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 12 of the aerosol-generating article 100 is located adjacent to the inductor 240 so that the susceptor 44 of the aerosol-generating article 100 is located within this alternating magnetic field. When the alternating magnetic field penetrates the susceptor 44, the alternating magnetic field causes heating of the susceptor 44. For example, eddy currents are generated in the susceptor 44 which is heated as a result. Further heating is provided by magnetic hysteresis losses within the susceptor 44. The heated susceptor 44 heats the aerosol-forming substrate 12 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 44. The controller may receive an input from a puff sensor 360, as will be described.

FIG. 6 illustrates the relationship between the DC current I_{DC} drawn from the power source 310 over time as the temperature of the susceptor 44 (the temperature is indicated by the dashed line 620) increases. The DC current is shown as line 600. The DC current I_{DC} drawn from the power source 310 is measured at an input side of the DC/AC converter 340. For the purpose of this illustration, it may be assumed that the voltage V_{DC} of the power source 310 remains approximately constant. The inductor and the susceptor form part of an inductive heating arrangement. As the susceptor 44 is inductively heated, the apparent resistance of the inductive heating arrangement and the susceptor itself increases and, as conductance is the inverse of resistance, the apparent conductance of the inductive heating arrangement decreases. The increase in resistance is observed as a decrease in the DC current I_{DC} drawn from the power source 310, which at constant voltage decreases as the temperature of the susceptor 44 increases. The high frequency alternating magnetic field provided by the inductor 240 induces eddy currents in close proximity to the susceptor surface, an effect that is known as the skin effect. The resistance in the susceptor 44 depends in part on the electrical resistivity of the first susceptor material, the resistivity of the second susceptor material and in part on the depth of the skin layer in each material available for induced eddy currents, and the resistivity is in turn temperature dependent. As the second susceptor material reaches its Curie temperature, it loses its magnetic properties. This causes an increase in the skin layer available for eddy currents in the second susceptor material, which causes a decrease in the apparent resistance of the susceptor 44. The result is a temporary increase in the detected DC current I_{DC} when the skin depth of the second susceptor material begins to increase, the resistance begins to fall. This is seen as the valley 602 (the local minimum) in FIG. 6. The current continues to increase until the maximum skin depth is reached, which coincides with the point where the second susceptor material has lost its spontaneous magnetic properties. This point is called the Curie temperature and is seen as the hill 601 (the local maximum) in FIG. 6. At this point the second susceptor material has undergone a phase change from a ferro-magnetic or ferri-magnetic state to a paramagnetic state. At this point, the susceptor 44 is at a known temperature (the Curie temperature, which is an intrinsic material-specific temperature). If the inductor 240 continues to generate an alternating magnetic field (i.e. power to the DC/AC converter 340 is not interrupted) after the Curie temperature has been reached, the eddy currents generated in the susceptor 44 will run against the resistance of the susceptor 44, whereby Joule heating in the susceptor 44 will continue, and thereby the resistance will increase again (the resistance will have a polynomial dependence of the temperature, which for most metallic susceptor materials can be approximated to a third degree polynomial dependence for our purposes) and current will start falling again as long as the inductor 240 continues to provide power to the susceptor 44.

Therefore, as can be seen from FIG. 6, the apparent resistance of the susceptor 44 (and correspondingly the current I_{DC} drawn from the power source 310) may vary with the temperature of the susceptor 44 in a strictly monotonic relationship over certain ranges of temperature of the susceptor 44. The strictly monotonic relationship allows for an unambiguous determination of the temperature of the susceptor 44 from a determination of the apparent resistance or apparent conductance (1/R). This is because each determined value of the apparent resistance is representative of only one single value of the temperature, so that there is no ambiguity in the relationship. The monotonic relationship of the temperature of the susceptor 44 and the apparent resistance allows for the determination and control of the temperature of the susceptor 44 and thus for the determination and control of the temperature of the aerosol-forming substrate 12. The apparent resistance of the susceptor 44 can be remotely detected by monitoring at least the DC current I_{DC} drawn from the DC power source 310.

At least the DC current I_{DC} drawn from the power source 310 is monitored by the controller 330. Preferably, both the DC current I_{DC} drawn from the power source 310 and the DC supply voltage V_{DC} are monitored. The controller 330 regulates the supply of power provided to the heating arrangement 320 based on a conductance value or a resistance value, where conductance is defined as the ratio of the DC current I_{DC} to the DC supply voltage V_{DC} and resistance is defined as the ratio of the DC supply voltage V_{DC} to the DC current I_{DC}. The heating arrangement 320 may comprise a current sensor (not shown) to measure the DC current I_{DC}. The heating arrangement may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power P_{AC} to the inductor 240.

The controller 330 may control the temperature of the susceptor 44 by maintaining an electrical control parameter, which may be the measured apparent conductance value or the measured apparent resistance value, at a target value corresponding to a target operating temperature of the susceptor 44. The controller 330 may use any suitable control loop to maintain the measured conductance value or the measured resistance value at the target value, for example by using a proportional-integral-derivative control loop.

In order to take advantage of the strictly monotonic relationship between the apparent resistance (or apparent conductance) of the susceptor 44 and the temperature of the susceptor 44, during user operation for producing an aerosol, the conductance value or the resistance value associated with the susceptor and measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill 601 in the current plot in FIG. 6). The first calibration temperature is a temperature greater than or equal to the temperature of the susceptor at which the skin depth of the second susceptor material begins to increase (leading to a temporary lowering of the resistance). Thus, the first calibration temperature is a temperature greater than or equal to the temperature at maximum permeability of the second susceptor material. The first calibration temperature is preferably at least 50 degrees Celsius lower than the second calibration temperature. At least the second calibration value may be determined by calibration of the susceptor 44, as will be described in more detail below. The first calibration value and the second calibration value may be stored as calibration values in a memory of the controller 330.

Since the conductance (resistance) will have a polynomial dependence on the temperature, the conductance (resistance) will behave in a nonlinear manner as a function of temperature. However, the first and second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the conductance is regulated according to the first calibration value and the second calibration value, through linear equations. For example, if the first and the second calibration values are conductance values, the target conductance value corresponding to the target operating temperature may be given by:

$${G}_{Target} = {G}_{Lower} + ( x \times Δ G )$$

where ΔG is the difference between the first conductance value and the second conductance value and x is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 44, and simultaneously the DC supply voltage V_{DC} and the DC current I_{DC} may be measured, preferably every millisecond for a period of 100 milliseconds. If the conductance is monitored by the controller 330, when the conductance reaches or exceeds a value corresponding to the target operating temperature, the duty cycle of the switching transistor 410 is reduced. If the resistance is monitored by the controller 330, when the resistance reaches or goes below a value corresponding to the target operating temperature, the duty cycle of the switching transistor 410 is reduced. For example, the duty cycle of the switching transistor 410 may be reduced to about 9%. In other words, the switching transistor 410 may be switched to a mode in which it generates pulses only every 10 milliseconds for a duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 44 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 44. The probing pulses are isolated power pulses having an intensity such not to heat the susceptor 44 but rather to obtain a feedback on the conductance value or resistance value and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to perform a calibration process in order to obtain the calibration values at which the conductance is measured at known temperatures of the susceptor 44. The known temperatures of the susceptor may be the first calibration temperature corresponding to the first calibration value and the second calibration temperature corresponding to the second calibration value. Preferably, the calibration process is performed each time the user operates the aerosol-generating device 200, for example each time the user inserts an aerosol-generating article 100 into an aerosol-generating device 200.

During the calibration process, the controller 330 controls the DC/AC converter 340 to continuously or continually supply power to the inductor 240 in order to heat the susceptor 44. The controller 330 monitors the conductance or resistance associated with the inductive heating arrangement or the susceptor 44 by measuring the current I_{DC} drawn by the power supply and, optionally the power supply voltage V_{DC}. As discussed above in relation to FIG. 6, as the susceptor 44 is heated, the measured current decreases until a first turning point 602 is reached and the current begins to increase. This first turning point or valley 602 corresponds to a local minimum conductance value (a local maximum resistance value). The controller 330 may record the local minimum value of conductance (or local maximum of resistance) as the first calibration value. The controller may record the value of conductance or resistance at a predetermined time after the minimum current has been reached as the first calibration value. The conductance or resistance may be determined based on the measured current I_{DC} and the measured voltage V_{DC}. Alternatively, it may be assumed that the power supply voltage V_{DC}, which is a known property of the power source 310, is approximately constant. The temperature of the susceptor 44 at the first calibration value is referred to as the first calibration temperature. Preferably, the first calibration temperature is between 150 degrees Celsius and 350 degrees Celsius. More preferably, when the aerosol-forming substrate 12 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the measured current increases until a second turning point 601 is reached and a maximum current is observed (corresponding to the Curie temperature of the second susceptor material) before the measured current begins to decrease. This turning point or hill 601 corresponds to a local maximum conductance value (a local minimum resistance value). The controller 330 records the local maximum value of the conductance (or local minimum of resistance) as the second calibration value. The temperature of the susceptor 44 at the second calibration value is referred to as the second calibration temperature. Preferably, the second calibration temperature is between 200 degrees Celsius and 400 degrees Celsius. When the maximum is detected, the controller 330 controls the DC/AC converter 340 to interrupt provision of power to the inductor 240, resulting in a cooling of the susceptor.

This calibration process of continuously heating the susceptor 44 to obtain the first calibration value and the second calibration value may be repeated at least once to improve reliability of the calibration.

In order to further improve the reliability of the calibration process, the controller 310 may be optionally programmed to perform a pre-heating process before the calibration process. For example, if the aerosol-forming substrate 12 is particularly dry or in similar conditions, the calibration may be performed before heat has spread within the aerosol-forming substrate 12, reducing the reliability of the calibration values. If the aerosol-forming substrate 12 were humid, the susceptor 44 takes more time to reach the valley temperature (due to water content in the substrate 12).

To perform the pre-heating process, the controller 330 is configured to continuously provide power to the inductor 240. As described above, the current starts decreasing with increasing susceptor 44 temperature until the minimum is reached. At this stage, the controller 330 is configured to wait for a predetermined period of time to allow the susceptor 44 to cool before continuing heating. The controller 330 therefore controls the DC/AC converter 340 to interrupt provision of power to the inductor 240. After the predetermined period of time, the controller 330 controls the DC/AC converter 340 to provide power until the minimum is reached. At this point, the controller controls the DC/AC converter 340 to interrupt provision of power to the inductor 240 again. The controller 330 again waits for the same predetermined period of time to allow the susceptor 44 to cool before continuing heating. This heating and cooling of the susceptor 44 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 12 is dry, the first minimum of the pre-heating process is reached within the pre-determined period of time and the interruption of power will be repeated until the end of the predetermined time period. If the aerosol-forming substrate 12 is humid, the first minimum of the pre-heating process will be reached towards the end of the pre-determined time period. Therefore, performing the pre-heating process for a predetermined duration ensures that, whatever the physical condition of the substrate 12, the time is sufficient for the substrate 12 to reach the minimum temperature, in order to be ready to feed continuous power and reach the first maximum. This allows a calibration as early as possible, but still without risking that the substrate 12 would not have reached the valley beforehand.

Further, the aerosol-generating article 100 may be configured such that the minimum is always reached within the predetermined duration of the pre-heating process. If the minimum is not reached within the pre-determined duration of the pre-heating process, this may indicate that the aerosol-generating article 100 comprising the aerosol-forming substrate 12 is not suitable for use with the aerosol-generating device 200. For example, the aerosol-generating article 100 may comprise a different or lower-quality aerosol-forming substrate 12 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to cease operation of the aerosol-generating device 200.

The pre-heating process may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200.

Following the pre-heating process and the calibration process, the controller 330 controls the DC/AC converter 340 to maintain the conductance or resistance associated with the susceptor 44 at a target value. This is referred to as the heating process or operational heating mode. The target value may change over time in a continuous or step-wise manner but will always be between the maximum and minimum values determined during the calibration process. A recalibration process may be performed at set time intervals during the heating process in order to re-establish the maximum and minimum values, which may drift over a period of use of the device.

In order to maintain the conductance or resistance associated with the susceptor 44 at the target value, controller 330 varies the duty cycle of the DC/AC converter 340. If the susceptor is cooled by an increased airflow past the susceptor, such as during a user puff on the system, the conductance associated with the susceptor will fall. The controller 330 will then increase the duty cycle of the pulses of current to increase the power provided to the inductor and thereby bring the conductance of the susceptor back towards the target value.

In order to prevent overheating of the device or the susceptor during operation one or more safety processes may be implemented. One safety process, schematically illustrated with respect to FIGS. 7, 8, and 9, involves monitoring the response of the electrical control parameter to pulses of current supplied to the inductive heating arrangement, that is the response of apparent conductance to supplied current, to check that a predetermined condition is met. The predetermined condition is that the conductance values rise over the duration of each pulse during the operational heating mode. If this condition is not met then the controller implements a recovery mode in which the susceptor is allowed to cool and a recalibration is undertaken to determine an updated target value of the conductance.

FIG. 7 shows the response of a calculated apparent conductance of an inductive heating arrangement to continuous supply of power, for example as in a calibration mode as described above. It is noted that a calibration mode is unlikely to result in heating of the susceptor substantially beyond the maxima noted by reference numeral 704, as this may result in the susceptor overheating. The line 705 is continued beyond the maxima 704 in FIG. 7 for illustrative purposes. The article and device are as described above. On supplying current to the inductor, the temperature of the susceptor rises. As the temperature of the susceptor rises, its conductance initially falls 701. The susceptor includes a portion of material (such as a nickel alloy) that undergoes a phase transition, specifically a Curie transition from a ferromagnetic phase to a paramagnetic phase, at a particular temperature (for example within a temperature range of about 300-400° C.). As described above, the onset of this transition is detectable by a local minima 702 in conductance. As the temperature of the susceptor continues to rise with continued current supply, the phase transition proceeds and the conductance continues to rise 703. At the Curie temperature of the transitioning susceptor material the phase transition is complete. This is detectable by a local maxima 704 of conductance. The relationship of conductance to temperature now reverts to its original state, and conductance decreases with increasing temperature 705.

By operating a calibration mode, values of apparent conductance can be matched with temperature for any particular inductive heating arrangement (i.e. that formed by a specific inductor/susceptor couple). Thus, because the Curie temperature is known, this temperature can be determined to be equal to the value of apparent conductance at the local maxima 704. The temperature of the susceptor can then be controlled with reference to a target value of the apparent conductance 750 set between the local minima 702 and the local maxima 704 of the calibrated conductance time curve.

It is notable that the target value of apparent conductance is set between the minima 702 and the maxima 701. In this region, the apparent conductance increases with increase in temperature. Either side of the phase transition, i.e. before the minima 702 or after the maxima 704 the apparent conductance decreases with temperature. It is also notable that while the target value of apparent conductance 750 equates to a target operating temperature while the susceptor is undergoing its phase transition (i.e. between the minima 702 and maxima 704), the s-shape of the curve means that the same value of apparent resistance also occurs at a lower temperature, and a higher temperature.

During a heating mode to generate an aerosol current is supplied to the inductive heating arrangement as pulses of current, and these pulses are controlled with reference to a target value of the apparent conductance, as described above. To check that the temperature of the susceptor is being controlled correctly, the response of the apparent conductance to the pulses of current is determined. If the susceptor is being maintained at the correct temperature, the apparent conductance will rise as a response to a pulse of current. This confirms that the temperature of the susceptor is between the maxima and minima determined by the calibration and that by controlling with reference to the target value of apparent conductance, the desired operating temperature is being achieved. If the apparent conductance does not meet this predetermined criteria that it should rise in response to a pulse of current, then a fault may be assumed and the controller implements a recovery mode in which the susceptor is allowed to cool and a calibration mode is performed.

The curve illustrated in FIG. 7 is an example of the response of apparent conductance to a calibration mode. Such a mode may be carried out when an article is inserted into a device prior to generate an aerosol. A number of scenarios may occur which invalidate the calibration and potentially result in the temperature of the susceptor being maintained incorrectly.

For example, it may be that the article is incorrectly inserted into the device when the calibration is undertaken. Notwithstanding this, the device regulates the temperature normally at the conductance target value 750 determined by calibration. During use, however, the article may be further pushed into the device, thereby moving the susceptor relative to the inductor. This causes the S-curve to shift down from its initial calibrated value 700 to a new position 800, as illustrated in FIG. 8.

The problem is that the conductance target value 750 is now located above the maxima 804 of the new s-curve 800. As a result, the device attempts to control the supply of current with reference to the calibrated target value 750, but this target value cannot be reached due to the repositioning of the s-curve such that the new maxima 804 is the maximum conductance value which can be reached. The device continues heating in order to meet the calibrated conductance target 750, but eventually reaches the new maxima 804. After reaching the new maxima 804 the device continues the heating until it actually passes the maxima 804. After the maxima 804, the response of conductance to temperature is inverted, meaning that a power pulse triggers causes a decrease in apparent conductance.

The effect can be seen in FIG. 9. After the initial calibration, a target conductance 750 is set, between maxima 704 and minima 702 of the calibration curve. Initially, during a heating mode, pulses of current are supplied to the inductive heating arrangement and controlled with reference to the target conductance value 750. Such controlled pulses are seen in the group of pulses 900 in FIG. 9. The slope of these pulses can be seen to be positive, as the conductance increases over the duration of each pulse. After the article is moved in the device, the s-curve is displaced as discussed above. The result is that the first pulse of current after this anomalous movement 905 registers a lower apparent conductance. Conductance increases with subsequent pulses as the controller attempts to raise the conductance to the target level 750. However, the new maxima 804 is lower than the target value 750, which means that the pulses of current are not controlled. As the temperature of the susceptor increases, the response of the apparent conductance to supplied power changes, and the conductance starts to fall with each pulse 910. Without a safety mechanism the temperature may keep increasing as conductance falls. However, when the first pulse is detected that does not demonstrate an increase in conductance over its duration (for example pulse 910) the controller initiates a recovery mode.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. An inductively heated aerosol-generating system, comprising:
an inductive heating arrangement having an inductor and a susceptor; and
a controller configured to
monitor an electrical control parameter during an operational heating mode,
maintain a temperature of the susceptor within an operational temperature range by controlling power supplied to the inductive heating arrangement with reference to a target value of the electrical control parameter,
determine whether a response of the electrical control parameter to the power supplied to the inductive heating arrangement during the operational heating mode meets a predetermined condition, and
implement a change in operation if the response does not meet the predetermined condition,
wherein power is supplied to the inductive heating arrangement as a plurality of discrete pulses of current,
wherein the response of the electrical control parameter is analyzed for each pulse of current of the plurality of discrete pulses of current to determine whether a value of the electrical control parameter rises or falls during the pulse,
wherein at least a portion of the susceptor is configured to undergo a reversible phase transition when heated through a predetermined temperature range, the controller being further configured to identify upper and lower boundary values of the electrical control parameter associated with upper and lower boundaries of the phase transition, and
wherein the target value of the electrical control parameter is set to a value between the upper and the lower boundary values.

16. The aerosol-generating system according to claim 15, wherein the controller is further configured to maintain the temperature of the susceptor within the operational temperature range by supplying power to the inductive heating arrangement, monitoring the electrical control parameter, and modifying the power supplied to the inductive heating arrangement when the value of the electrical control parameter matches the target value of the electrical control parameter.

17. The aerosol-generating system according to claim 15, wherein the controller is further configured to supply pulses of current to the inductive heating arrangement to maintain the temperature of the susceptor within the desired operational temperature range.

18. The aerosol-generating system according to claim 17, wherein the determining of whether the response of the electrical control parameter to the power supplied to the inductive heating arrangement during the operational heating mode meets a predetermined condition is conducted for said each pulse of current of the plurality of discrete pulses of current.

19. The aerosol-generating system according to claim 17, wherein the change in operation is implemented if the predetermined condition is not met over a duration of a pulse.

20. The aerosol-generating system according to claim 15, wherein the electrical control parameter is a parameter selected from the list consisting of: electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement.

21. The aerosol-generating system according to claim 15, wherein the predetermined condition is that the value of the electrical control parameter rises in response to the power supplied to the inductive heating arrangement during the operational heating mode.

22. The aerosol-generating system according to claim 21, wherein the predetermined condition is that the value of the electrical control parameter rises toward the target value of the control parameter in response to the power supplied to the inductive heating arrangement during the operational heating mode.

23.-25. (canceled)

26. The aerosol-generating system according to claim 15,
wherein the power is supplied to the inductive heating arrangement as a plurality of discrete pulses of current, and
wherein the response to the electrical control parameter is analyzed for each pulse of current of the plurality of discrete pulses of current to determine whether a slope of the electrical control parameter versus time curve increases or decreases over a duration of the pulse.

27. The aerosol-generating system according to claim 26, wherein the electrical control parameter is apparent conductance of the inductive heating system, and the control parameter is analyzed for said each pulse of current of the plurality of discrete pulses of current to determine whether the value of the electrical control parameter rises or falls over the duration of the pulse.

28. The aerosol-generating system according to claim 27, wherein the controller is further configured to switch from the heating mode to a recovery mode if the controller detects that the value of the electrical control parameter falls over the duration of a pulse.

29. The aerosol-generating system according to claim 27, wherein the controller is further configured to allow the susceptor to cool if the controller detects that the value of the electrical control parameter falls over the duration of a pulse.

30. The aerosol-generating si stem according to claim 29, wherein the controller is further configured to allow the susceptor to cool, upon detection that the value of the electrical control parameter falls over the duration of a pulse, by reducing a duty cycle of power supplied to the inductive heating arrangement.
